(19) United States
(12) Patent Application Publication
(10) Pub. No.: US 2011/0122054 A1
(43) Pub. Date: May 26, 2011

(54) LIQUID CRYSTAL DISPLAY DEVICE

(75) Inventors: Masahiro Shimizu, Osaka (JP); Takashi Katayama, Osaka (JP)

(73) Assignee: SHARP KABUSHIKI KAISHA, Osaka (JP)

(21) Appl. No.: 13/003,759

(22) PCT Filed: Jul. 15, 2009
(86) PCT No.: PCT/JP2009/062781

§ 371 Date: Jan. 11, 2011

(30) Foreign Application Priority Data
Aug. 11, 2008 (JP) 2008-207039

(51) Int. Cl. G09G 3/36

(52) U.S. Cl. 345/87

(57) ABSTRACT

An OCB-mode liquid crystal display device includes an accumulation capacitance bus line (13) arranged on a TFT substrate (20) so as to sandwich an insulation film (14) and superposed on a pixel electrode (11). The pixel electrode (11) has an opening (15) in a part of the region where the pixel electrode (11) and the accumulation capacitance bus line (13) are superposed via the insulation film (14). By causing a potential difference between the pixel electrode (11) and the accumulation capacitance bus line (13), a lateral electric field is generated in the vicinity of the opening (15) to form a nucleus for transition from the twist orientation to the spray orientation. When the power is turned off to stop display, it is possible to rapidly perform orientation transition from the twist orientation to the spray orientation.

### TECHNICAL FIELD

The present invention relates generally to liquid crystal display devices, and more specifically, to liquid crystal devices having an OCB (optically self-compensated birefringence) mode and capability for a rapid orientation transition from a twist orientation to a spray orientation.

### BACKGROUND ART

Liquid crystal display devices are in wide use in televisions, notebook personal computers, desktop personal computers, personal digital assistants, mobile phones, and other electronic devices, because liquid crystal display devices are thinner, lighter, operate at a lower voltage, and consume less power than the CRT (cathode ray tube) displays. Advances in the liquid crystal display technologies in recent years have made it possible to develop color liquid crystal display devices, which offer high contrast ratios and wide view angles and which are now in mainstream use for large panel display devices.

Among the color liquid crystal display devices widely used today are twisted nematic (TN) mode display devices, in which an electric field controls the optical polarity rotation in a liquid crystal layer, and electrically controlled birefringence (ECB) mode devices, in which an electric field controls the birefringence of the liquid crystal layer. The color liquid crystal display devices, which rely on these modes, however, have slow response times, are susceptible to image trailing and blurred outlines, and are not suited for displaying video images.

Many efforts have been made to improve the color LCD device response speeds, and new liquid crystal modes, such as a ferroelectric liquid crystal mode, anti-ferroelectric liquid crystal mode, optically self-compensated birefringence (OCB) mode, have been developed to achieve the fast response times suited for the video image display. Among these, the ferroelectric liquid crystal mode and anti-ferroelectric liquid crystal mode require a layered structure, which makes the liquid crystal display less resistant to mechanical shocks, and are known to be unsuited for commercial applications. On the other hand, a liquid crystal display device with the OCB mode is based on a standard nematic liquid crystal display, can withstand mechanical shocks, and has a wide operating temperature range, wide view angles, and fast response characteristics. Therefore, it is considered suitable for video display.

FIG. 13 and FIG. 14 are cross-sectional schematics showing the structural outlines of a conventional liquid crystal display device 100 using the OCB mode. FIG. 13 shows its state under no electrical bias, while FIG. 14 shows its state under an electrical bias.

A liquid crystal panel 102 in the liquid crystal display device 100 includes a color filter substrate 110 and a TFT substrate 115, which face each other, and a liquid crystal layer 121, which includes liquid crystal molecules 120 and which is disposed between the two substrates.

The color filter substrate 110 includes a first glass substrate 105 on which an opposing electrode 106, a color filter, which is not shown in the figure, and an alignment film 107 are formed. Here, the color filter is used in the case of color display. The descriptions here assume that the display is in color.

The TFT substrate 115 includes a second glass substrate 111 on which a pixel electrode 112 and an alignment film 113 are formed. Formed on the second glass substrate 111 are gate bus lines, source bus lines, and thin film transistors (TFT) at the intersection of the two bus lines for active matrix drive of the liquid crystal.

The color filter substrate 110 and TFT substrate 115 face each other and are coupled together with an appropriate gap created with spherical spacers or columnar spacers, which are not shown in the figures. The color filter substrate 110 and TFT substrate 115 are coupled together, and the liquid crystal layer 121 is drip injected therebetween. Or the liquid crystal layer 121 is vacuum injected in between the color filter substrate 110 and TFT substrate 115.

An alignment treatment is performed on the color filter substrate 110 and on TFT substrate 115 in order to make the liquid crystal molecules 120 achieve a parallel and uniform orientation in the OCB mode. Furthermore, a phase difference plate is placed on the surface of each substrate in order to improve the display view angle characteristics, and polarizing plates are placed on both substrates in such a way as to achieve a crossed Nicols state. The phase difference plate may, for example, be a negative phase difference plate having the primary axes arranged in a hybrid manner.

As shown in FIG. 13 and FIG. 14, when no electrical bias is applied, the liquid crystal molecules 120 tend to have an orientation shown in FIG. 13 in the liquid crystal display device 100 in the OCB mode. This state will be called the initial orientation (spray orientation) hereinafter. When a prescribed voltage is applied between the opposing electrode 106 on the color filter substrate 110 and the pixel electrode 112 on the TFT substrate 115, the orientation transitions gradually into a direction shown in FIG. 14. This state will be called the bend orientation. Once the bend orientation in FIG. 14 is achieved, the liquid crystal orientation changes with high speed responses, and the fastest display among all the modes utilizing the nematic liquid crystal is realized. A combination with the phase difference plates results in a display with wide view angle characteristics. Color display is performed in the bend orientation state.

A rapid orientation transition from the spray orientation to the bend orientation requires a relatively large voltage and a long time period. Furthermore, it is known that the orientation transition tends to originate at areas where several spacers are clustered and then spreads out therefrom. For example, Patent Document 1 describes that a transition nucleus, where an orientation transition originates, is formed in each of the pixels across a display so that the bend orientation originates at these transition nuclei.

In order to maintain the bend orientation, however, a certain level of voltage must constantly be applied. Suppose that the minimum voltage level required for maintaining the bend orientation is Vcr. Then, the bend orientation would no longer be maintained once the voltage drops to Vcr or less. The orientation would immediately transition to those shown in FIG. 15. This state is called the twist orientation hereinafter. Later, as the time passes, the orientation state gradually transitions back to the spray orientation (FIG. 13), which is the initial orientation. With the OCB mode, in other words, the initial state is the spray orientation, under no bias voltage. The orientation transitions to the bend orientation when a prescribed voltage is applied between the opposing electrode 106 and pixel electrode 112. Once the voltage drops to Vcr or below while the orientation is the bend orientation, a transition from the bend orientation to the twist orientation takes place, followed by a gradual transition to the spray orientation.

Therefore, when a power supply to the panel or the device is turned off to terminate the display while the display is in the bend orientation state, the orientation changes instantaneously to the twist orientation and then gradually transitions to the spray orientation. The orientation transition from the twist orientation to the spray orientation is called the reverse transition. While the transition from the bend orientation to the twist orientation is not subject to much hysteresis, and the transition takes place instantaneously under a voltage bias, the speed of the reverse transition back to the spray orientation is very slow, and it takes several minutes to tens of minutes for the entire display to transition to the spray orientation. The reverse transition tends to originate at locations that are not in the bend orientation, such as non-display portions at the periphery of the display and areas where several spacers are clustered, and then gradually spreads across the entire display.

FIG. 16 is a schematic representing the orientation state at 5 seconds after the power supply is turned off, as observed using a microscope. As shown in FIG. 16, a mixture of the spray orientation and the twist orientation results in spot patterns across the display. In other words, there is a problem in that the reverse transition originates at very few nucleation sites, and as a result, a mixture of twist orientations and spray orientation remains while the reverse transition spreads out. Spotted patterns are observed on the display as long as such a state persists. This would not be a significant problem with a transmission-type liquid crystal display device, as long as the backlight is turned off simultaneously as the power supply is turned off. However, the problem is significant with a reflection-type liquid crystal display device or a reflection-transmission-type liquid crystal display device, which rely on the ambient light as a light source.

The liquid crystal display device described in Patent Document 1 realizes a rapid orientation transition from the spray orientation to the bend orientation by having a transition nucleus, where the orientation transition originates, in every pixel across the display and by having the bend orientation originate from the transition nuclei. This liquid crystal display device nevertheless does not realize a reverse transition from the twist orientation to the spray orientation without exposing the spots, as described above. Furthermore, a liquid crystal display device that realizes a reverse transition from the twist orientation to the spray orientation without exposing the spots described above has not been described in any documents.

### Prior Art Documents

### Patent Documents

Patent Document 1: Japanese Patent Application Laid-Open Publication 2003-107506 (published on Apr. 9, 2003)

### SUMMARY OF THE INVENTION

The present invention has been made in consideration of the problems described above. An object of the present invention is to provide a liquid crystal display device capable of achieving a rapid orientation transition from the twist orientation to the spray orientation.

A liquid display device of the present invention solves the problems described above and includes a first substrate, a second substrate, a liquid crystal layer sealed between the aforementioned first substrate and the aforementioned second substrate; and a plurality of pixels laid out in a matrix; where the aforementioned first substrate includes a pixel electrode corresponding to each pixel of the plurality of pixels. The LCD display device is an OCB-mode liquid crystal display device in which liquid crystal molecules in the aforementioned liquid crystal layer are in a spray orientation when no voltage is applied on the aforementioned liquid crystal layer; transition from the spray orientation to a bend orientation when a voltage is applied on the aforementioned liquid crystal layer, and transition from the bend orientation to a twist orientation when the voltage applied drops to or below a specific level while in the bend orientation state. The liquid crystal display device further includes a bus line formed on the aforementioned first substrate to overlap aforementioned pixel electrode with an insulating layer interposed therebetween to apply a voltage relative to the aforementioned pixel electrode; and an opening formed in the aforementioned pixel electrode in a portion of a region over which the aforementioned pixel electrode overlaps with the aforementioned bus line with the aforementioned layer interposed therebetween.

In the structure described above, a prescribed voltage is applied between the pixel electrode and the bus line when an image display is stopped in the liquid crystal display device of the present invention. By thus applying the voltage, an electric field for transitioning the liquid crystal layer from the twist orientation to the spray orientation is generated from the opening. The present inventors have discovered, as a result of dedicated research efforts, that due to the electric field, the liquid crystal molecules cannot maintain the twist orientation, an orientation transition to the spray orientation is induced, and that a rapid orientation transition from the twist orientation to the spray orientation is realized.

As thus described, the electric field is generated in the opening as a result of a prescribed voltage applied between the pixel electrode and the bus line in the liquid crystal display device of the present invention. As a result, a rapid orientation transition from the twist orientation to the spray orientation is effectively realized. Furthermore, the liquid crystal display device of the present invention solves the problems of the conventional art, which are: a long time span required for the entire display to transition from the twist orientation to the spray orientation because the spray orientation originates at the peripheral portions of the display that are not in the bend orientation, and spreads gradually across the display; and a spot pattern on the display caused by a mixture of the twist orientation and spray orientation across the display.

### BRIEF DESCRIPTION OF THE DRAWINGS

FIG. 1 is a cross-sectional diagram of a liquid crystal display device according to a preferred embodiment of the present invention.

FIG. 2 is a plan view schematic outlining a pixel on a TFT substrate of a liquid crystal display device according to a preferred embodiment of the present invention.

FIG. 3 is a plan view schematic outlining a structure of a pixel on a TFT substrate of a liquid crystal display device according to a preferred embodiment of the present invention and shows a structure having an opening created on a gate bus line.

FIG. 4 is a plan view schematic outlining a structure of a pixel on a TFT substrate of a liquid crystal display device according to a preferred embodiment of the present invention and shows a structure having an opening on a source bus line.

FIG. 5 is a diagram showing signal lines for displaying an image on a liquid crystal display panel.

FIG. 6 is a diagram showing the flow of each signal during an orientation transition from a twist orientation to a spray orientation.

FIG. 7 represents a state immediately after a voltage of 0 V is applied on an accumulation capacitance bus line after a voltage of +10 V has been applied only on the accumulation capacitance bus line.

FIG. 8 shows a relationship between voltages applied on the accumulation capacitance bus line and the insulating film thicknesses.

FIG. 9 is a plan view schematic outlining a structure of a pixel on a TFT substrate in another liquid crystal display device according to a preferred embodiment of the present invention.

FIG. 10 is a cross-sectional diagram of another liquid crystal display device according to a preferred embodiment of the present invention.

FIG. 11 is a cross-sectional diagram of another liquid crystal display device according to a preferred embodiment of the present invention.

FIG. 12 is a cross-sectional diagram of another liquid crystal display device according to a preferred embodiment of the present invention.

FIG. 13 is a cross-sectional schematic showing a spray orientation under no voltage bias in a conventional liquid crystal display device of the OCB mode.

FIG. 14 is a cross-sectional schematic of a bend orientation under a voltage bias in the conventional liquid crystal display device of the OCB mode.

FIG. 15 is a cross-sectional schematic of a twist orientation in the conventional liquid crystal display device of the OCB mode.

FIG. 16 is a diagram showing a mixture of spray orientation and twist orientation presenting a spot pattern.

### DETAILED DESCRIPTION OF EMBODIMENTS

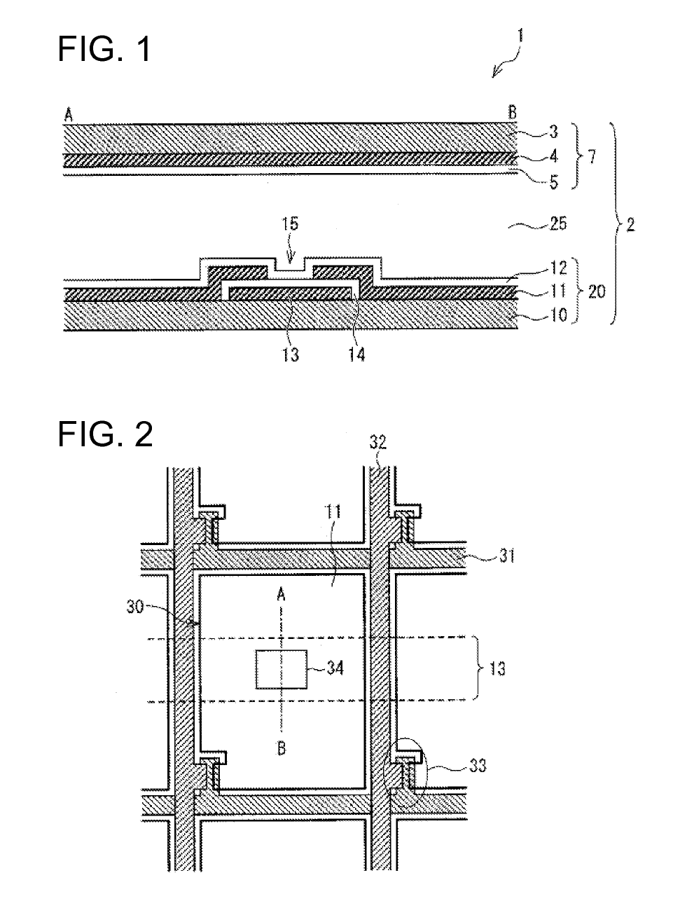

A preferred embodiment of the present invention will be described with reference to FIG. 1 and FIG. 2. FIG. 1 is a cross-sectional diagram (at the line A-B in FIG. 2) of a liquid crystal display device 1 of the OCB mode according to this preferred embodiment, while FIG. 2 is a plan view schematic outlining a structure of a pixel on a TFT substrate 20 of the liquid crystal display device 1.

As shown in FIG. 1, a liquid crystal panel 2 in the liquid crystal display device 1 includes an opposing substrate (second substrate) 7 and a TFT substrate (first substrate 20), which face each other, and a liquid crystal layer 25 is sealed between the two substrates.

The opposing substrate 7 includes a first glass substrate 3, which is a base substrate. A color filter, which is not shown in the figure, an opposing electrode 4, and an alignment film 5 are formed in that order on the first glass substrate 3 from the side of the first glass substrate 3. The color filter is used in the case of color display. The description provided here assumes that the display is in color.

On the other hand, the TFT substrate 20 includes a second glass substrate 10, which is a base substrate. A pixel electrode 11 and an accumulation capacitance bus line (bus line) 13 are formed on the side of the second glass substrate 10 that faces the opposing substrate 7. Furthermore, an insulating film (insulating layer) 14 is formed between the pixel electrode 11 and the accumulation capacitance bus line 13 to insulate the pixel electrode 11 and the accumulation capacitance bus line 13 from each other. Furthermore, as shown in FIG. 1, the accumulation capacitance bus line 13 is formed on the second glass substrate 10 in such a way as to overlap the pixel electrode 11 through the insulating film 14 interposed therebetween. Furthermore, an opening 15 is formed in the pixel electrode 11 in a portion of an area over which the pixel electrode 11 and the accumulation capacitance bus line 13 overlap through the insulating film 14 interposed therebetween. Furthermore, an alignment film 12 is formed in such a way as to cover the insulating film 14 exposed at the opening 15 and the pixel electrode 11.

Also formed in the pixel electrode 11 are a gate bus line, a source bus line, and a thin film transistor (TFT) at an intersection of the bus lines, none of which is shown in the figure, for an active matrix drive of the liquid crystal. Furthermore, the alignment film 5 and the alignment film 12 have gone through orientation treatments for achieving a parallel and uniform orientation of the liquid crystal molecules.

The TFT substrate 20 will be described next with reference to FIG. 2. FIG. 2 is a plan view schematic outlining a structure of a pixel on the TFT substrate 20 in the liquid crystal display device 1.

As shown in FIG. 2, a pixel electrode 11; a gate bus line 31 and a source bus line 32 at the periphery of pixel electrode 11, which intersect with each other through an insulating layer, not shown in the figure, interposed therebetween; and a TFT 33 are formed in a pixel 30. Furthermore, the accumulation capacitance bus line 13 is formed in parallel with the gate bus line 31 near the center of the pixel electrode 11.

The opening 15, which is a transition nucleus, is formed where the pixel electrode 11 overlaps with the accumulation capacitance bus line 13. The transition nucleus here is for an orientation transition of liquid crystal molecules from a twist orientation to a spray orientation in the OCB mode. As it will be described later, the accumulation capacitance bus line 13 is placed beneath the opening 15, which is formed in the pixel electrode 11, and a potential difference is created between the pixel electrode 11 and the accumulation capacitance bus line 13; to generate a lateral electric field in the vicinity of the opening 15, thereby forming a nucleus for the transition from the twist orientation to the spray orientation. For this reason, the opening 15 is called a transition nucleus.

While FIG. 2 shows a single pixel 30 among a plurality of pixels that exist, the same description for the pixel 30 obviously also applies to any of the plurality of aforementioned pixels, which are laid out in a matrix. Alternately, the openings may be created only in some of the pixels among the plurality of pixels.

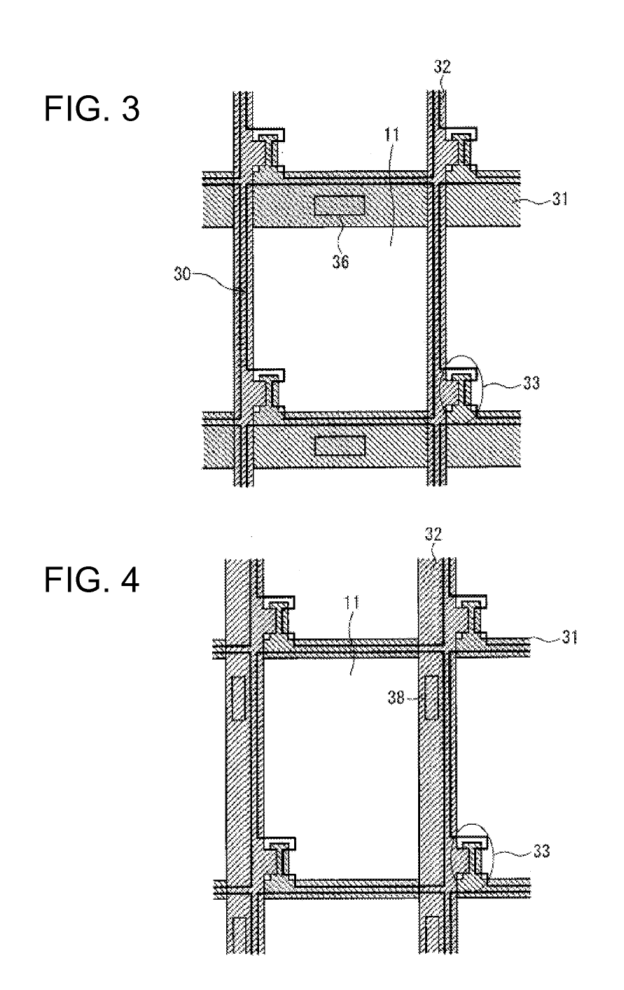

Furthermore, while the opening 15 is placed near the center of the pixel 30 and has a rectangular shape in FIG. 2, the opening 15 may take a shape other than a rectangle. Furthermore, while FIG. 1 shows the opening 15 formed in the vicinity of the center of the pixel 30, the opening 15 may be placed as shown in FIG. 3 or FIG. 4. In other words, the gate bus line 31 or the source bus line 32 may be used instead of the accumulation capacitance bus line 13.

Next, a method of manufacturing the liquid crystal display device 1 shown in FIG. 1 will be described.

First, a method of manufacturing the accumulation capacitance bus line 13 and other elements on the TFT substrate 20 will be described. A metallic film is first deposited by, for example, sputtering on the entire second glass substrate 10, which has gone through a base coat treatment, for example, and the accumulation capacitance bus line 13 is patterned by, for example, a photolithography process. While the accumulation capacitance bus line 13 that has been manufactured has a multilayer structure of Ta and its nitride, a multilayer structure may not be necessary. The accumulation capacitance bus line 13 may also be manufactured using a material like Ti, Al, other metal, or ITO. Then the surface of the accumulation capacitance bus line 13 is anode oxidized, and silicon nitride, for example, is deposited to from the insulating film 14. Here, the film formation may be by a method other than patterning.

A semiconductor layer is formed next by CVD, and patterning is accomplished by a photolithography process. Then, the source bus line 32 and drain electrode are formed by sputtering and patterned by a photolithography process. The material used for the source bus line 32 is a metal such as Ta, Ti, or Al, similar to the gate bus line 31 and the accumulation capacitance bus line 13. Finally, an insulating film cover is used to prevent diffusion of impurities into the TFT 33 and to improve the semiconductor performance. The accumulation capacitance bus line and other elements are thus manufactured on the TFT substrate 20.

Next, the pixel electrode 11 is manufactured by sputtering and patterned by a photolithography process. While ITO has been used for the pixel electrode 11, which is a transparent electrode, any material that is a thin film and transparent conductive material, such as IZO, may also be used.

The opposing substrate 7 is manufactured next. A black matrix, which divides the pixels, and an RGB color filter are manufactured on the first glass substrate 3 in a striped layout. Then ITO is sputtered as the opposing electrode 4. Next, a treatment for aligning the liquid crystal is performed on the TFT substrate 20 and on the opposing substrate 7. A detailed description of this alignment treatment is omitted from this description because it is based on conventionally known method.

The liquid crystal panel thus manufactured is shown in a plan view in FIG. 1 and in a cross-sectional diagram in FIG. 2.

Phase difference plates for view angle compensation are attached on both outer faces of the liquid crystal panel 2, and polarization plates are further attached on the outside of the phase difference plates in order to achieve wider view angles. The polarization plates are attached in such a way that the axes of polarization in the polarization plates are orthogonal with respect to the directions of rubbing.

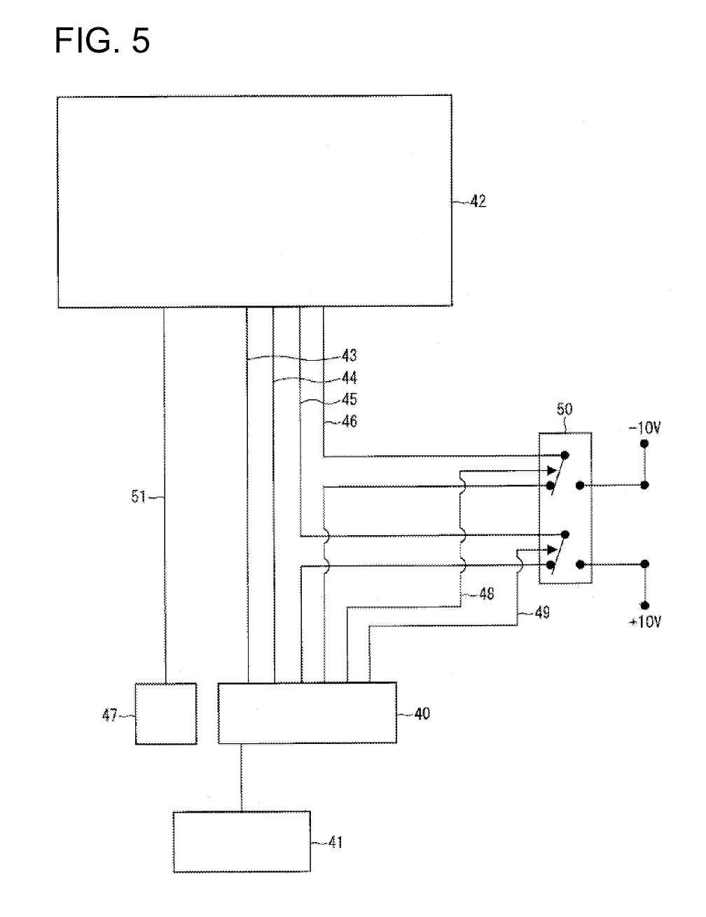

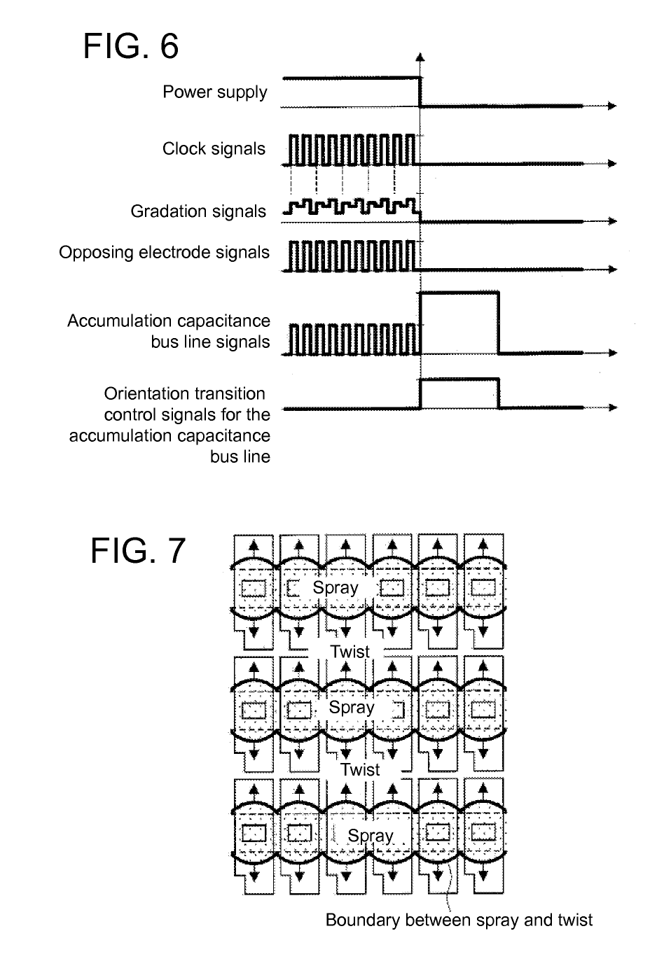

Next, operations for transitioning the orientation of the liquid crystal molecules contained in the liquid crystal layer from the spray orientation to the bend orientation, then from the bend orientation to the twist orientation, and finally from the twist orientation to the spray orientation will be described with reference to FIG. 5 and FIG. 6.

FIG. 5 is a diagram showing signal lines for displaying an image on the liquid crystal display panel. FIG. 6 is a diagram showing the flow of each signal, during an orientation transition from the twist orientation to the spray orientation.

As shown in FIG. 5, a liquid crystal control circuit 40, a signal source 41, a power supply circuit 47, and a relay circuit 50 are used for displaying an image on a liquid crystal panel 42. The function of the liquid crystal control circuit 40 is to convert image signals from the signal source 41 to signals for driving the liquid crystal panel 42. Signals from the liquid crystal control circuit 40 to the liquid crystal panel 42 include a clock signal 43 for synchronization with the liquid crystal panel 42; a gradation signal 44 for gradation; an accumulation capacitance bus line signal 45, which is an input to the accumulation capacitance bus line; and an opposing electrode signal 46, which is an input to the opposing electrode. Among these, the clock signal 43 and the gradation signal 44 are fed directly from the liquid crystal control circuit 40 to the liquid crystal panel 42. The accumulation capacitance bus line signal 45 and the opposing electrode signal 46 are fed from the liquid crystal control circuit 40 through the relay circuit 50 to the liquid crystal panel 42.

The relay circuit 50 switches upon receipt of a signal from the orientation transition control signal 48 (for the opposing electrode) and a signal from the orientation transition control signal 49 (for the accumulation capacitance bus line). The accumulation capacitance bus line signal 45 is either a signal from the liquid crystal control circuit 40 or a +10 V voltage input, depending on the switching. The opposing electrode signal 46 is either a signal from the liquid crystal control circuit 40 or a −10 V voltage input, depending on the switching in the relay circuit 50.

While the voltages applied are set to 10 V in FIG. 5, the voltage level is not limited to such a value and may vary.

A transition from the spray orientation to the bend orientation in the liquid crystal molecules contained in the liquid crystal layer in the liquid crystal panel 42 will be described next. First, when the power supply is turned on, a power supply signal 51, which represents the power supply being turned on, is fed from the power supply circuit 47 to the liquid crystal panel 42. Then, the liquid crystal control circuit 40 feeds an orientation transition control signal 48 (for the opposing electrode) and an orientation transition control signal 49 (for the accumulation capacitance bus line) as outputs, and respective switches in the relay circuit 50 switch upon receipt of these signals. As a result, a +10 V voltage on the accumulation capacitance bus line and a −10 V voltage on the opposing substrate electrode are applied as biases. A 20 V voltage is thus applied on the liquid crystal layer 25, and the liquid crystal molecules transition in orientation from the spray orientation to the bend orientation.

Then, after the liquid crystal molecules have transitioned into the bend orientation, the liquid crystal control circuit 40 again feeds an orientation transition control signal 48 (for the opposing electrode) and an orientation transition control signal 49 (for the accumulation capacitance bus line) as outputs. Upon receipt of these signals, the respective switches in the relay circuit 50 switch. Then, the orientation transition control signal 48 (for the opposing electrode) and the orientation transition control signal 49 (for the accumulation capacitance bus line) are fed from the liquid crystal control circuit 40 into the liquid crystal panel 42. As a result, the liquid crystal panel 42 displays an image while being in the bend orientation state.

When the power supply is turned off, all signals change to 0 V. As a result, the liquid crystal molecules begin an orientation transition from the bend orientation to the twist orientation. As described above, there is very little hysteresis between the bend orientation and the twist orientation. A transition from the bend orientation to the twist orientation takes place rapidly when all signals switch to 0 V.

As thus described, the liquid crystal display device 1 is an OCB mode liquid crystal display device having a structure, such that the liquid crystal molecules contained in the liquid crystal layer have the spray orientation when no voltage bias is applied on the liquid crystal layer; transition from the spray orientation to the bend orientation when a voltage bias is applied on the liquid crystal layer; and transition from the bend orientation to the twist orientation when the bias voltage being applied falls below a specific level while in the bend orientation.

Next, while the liquid crystal molecules are in the twist orientation state, only the orientation transition control signal 49 (for the accumulation capacitance bus line) is activated, and the relay circuit 50 is switched to provide a +10 V input only to the accumulation capacitance bus line. Then, after a certain amount of time has passed, only the orientation transition control signal 49 (for the accumulation capacitance bus line) is activated again, and the switch for the accumulation capacitance bus line in the relay circuit 50 is switched to apply a 0 V input to the accumulation capacitance bus line.

FIG. 6 is a diagram showing the flow of various signals described with reference to FIG. 5 and is referred to for describing the signal operations after the power supply is turned off. As shown in FIG. 6, the clock signal, gradation signal, opposing electrode signal, and accumulation capacitance bus line signal are applied as input to the liquid crystal panel until the power supply is turned off. Once the power supply is turned off, however, only the orientation transition control signal 49 (for the accumulation capacitance bus line) is activated, and a voltage is applied only on the accumulation capacitance bus line. Then, after a certain amount of time has passed, only the orientation transition control signal 49 (for the accumulation capacitance bus line) is activated, the switch for the accumulation capacitance bus line in the relay circuit 50 is switched, and a 0V input is applied on the accumulation capacitance bus line.

By applying a +10V voltage only on the accumulation capacitance bus line, a potential difference is generated between the pixel electrode 11 and the accumulation capacitance bus line 13, which are formed on different planes with the insulating film 14 interposed therebetween. As a result of this potential difference, a lateral electric field is generated from the opening 15 in a direction parallel to the second glass substrate 10.

This lateral electric field promotes an orientation transition in the liquid crystal molecules from the twist orientation to the spray orientation. In other words, the lateral electric field, which is in a direction parallel to the second glass substrate 10, forms a nucleus, from which the transition of the liquid crystal molecules from the twist orientation to the spray orientation originates, and induces the orientation transition from the twist orientation to the spray orientation.

Next, the effects of the orientation transition from the twist orientation to the spray orientation in the liquid crystal display device 1 in the preferred embodiment of the present invention will be described.

In the liquid crystal display device 1, the opening 15 is formed in the pixel electrode 11 in a portion of an area over which the pixel electrode 11 and the accumulation capacitance bus line 13 overlap through the insulating film 14 interposed therebetween. Therefore, it is possible to generate a lateral electric field from the opening 15 by creating a potential difference between the pixel electrode 11 and the accumulation capacitance bus line 13, while the liquid crystal layer 25 is in a twist orientation state. Then, because of this electric field, the liquid crystal molecules are unable to remain in the twist orientation, an orientation transition to the spray orientation is induced, and a rapid orientation transition from the twist orientation to the spray orientation is realized.

Furthermore, the liquid crystal display device 1 creates a potential difference between the pixel electrode and the bus line during the orientation transition from the twist orientation to the spray orientation, and applies no voltage bias between the pixel electrode and the opposing electrode. Therefore, the liquid crystal display device 1 realizes a rapid orientation transition from the twist orientation to the spray orientation without an orientation transition from the twist orientation to the bend orientation.

Thus, the liquid crystal display device 1 rapidly and effectively solves the problems in the conventional art that the orientation transition across the entire screen from the twist orientation to the spray orientation takes time because the spray orientation originates, for example, at the peripheral portions of the screen that are not in the bend orientation, and spreads gradually across the screen, and a mixture of the twist orientation and the spray orientation across the screen results in spot patterns on the screen.

Furthermore, while a plurality of pixels are placed in a matrix on the liquid crystal panel in the liquid crystal display device 1, the opening 15 may either be included in some of the pixels or in all of the pixels. When the opening 15 is included in all of the pixels, the orientation across the entire display may be transitioned from the twist orientation to the spray orientation in an amount of time required for one pixel to transition from the twist orientation to the spray orientation. As a result, a uniform spray orientation across the entire display is realized rapidly when the image display is stopped.

Furthermore, rubbing treatments on the alignment films 5 and 12 in the liquid crystal display device 1 preferably are performed in the same rubbing direction, respectively, and the lateral electric field is preferably applied in a direction parallel to the direction of rubbing.

The liquid crystal molecules in the twist orientation are twisted by 180 degrees between the opposing substrate 7 and the TFT substrate 20 and, at the center of the liquid crystal layer 25, are oriented in a direction orthogonal to the direction of rubbing. For this reason, when an electric field is applied on the liquid crystal molecules positioned at the center of the liquid crystal layer 25 in a direction parallel to the direction of rubbing, the liquid crystal molecules are unable to remain in the twist orientation. As a result, the liquid crystal molecules transition into the spray orientation. In other words, application of an electric field in a direction parallel (or in a direction anti-parallel) to the direction of rubbing more effectively realizes an orientation transition from the twist orientation to the spray orientation.

Furthermore, the insulating film 14 is preferably formed in such a way that its thickness in the vicinity of the opening 15 is smaller than the thickness in regions other than the vicinity of the opening 15.

In order for the liquid crystal molecules to transition from the twist orientation to the spray orientation, an electrical potential must be generated between the pixel electrode 11 and the accumulation capacitance bus line 13. The magnitude of this electric field increases with a larger potential difference between the pixel electrode 11 and the accumulation capacitance bus line 13 and with a smaller film thickness for the insulating film 14 formed between the pixel electrode 11 and the accumulation capacitance bus line 13. Therefore, even when the thickness of the insulating film 14 is larger in regions other than the vicinity of opening 15, an electric field may be generated more effectively from the opening 15 with a smaller film thickness for the insulating film 14 in the vicinity of the opening 15 regions. As a result, an orientation transition from the twist orientation to the spray orientation can be realized more effectively.

Furthermore, the accumulation capacitance bus line 13 may be the gate bus line 31 or the source bus line 32 formed on the TFT substrate 20.

Making the gate bus line 31 or the source bus line 32 formed on the TFT substrate 20 as the accumulation capacitance bus line 13 eliminates a need for forming a new bus line. As a result, a smaller liquid crystal display device, a simplified device, or a reduction in cost may be realized while a rapid orientation transition from the twist orientation to the spray orientation is also realized.

Furthermore, the liquid crystal display device 1 is preferably a reflection type having a reflective plate for reflecting the ambient light. Or the liquid crystal display device 1 may preferably be a reflection-transmission-type having a reflective plate for reflecting the ambient light and a backlight placed behind the TFT substrate 20.

When a mixture of spray orientation and twist orientation exists in the display, spot patterns appear in the display. This problem would not be significant in a transmission-type liquid crystal display device, as long as the backlight were turned off simultaneously when the power supply is turned off. However, the problem could become a significant issue in a reflection type liquid crystal display device and a reflection-transmission type liquid crystal display device, which rely on the ambient light as a light source. Therefore, an application of the liquid display device 1 to a reflection type or a reflection-transmission type can ensure an orientation transition from the twist orientation to the spray orientation and solves the problem of spot patterns described above.

### Preferred Embodiment 1

An orientation transition from the twist orientation to the spray orientation will be described according to a preferred embodiment. The description that follows will include specific numerical values, which are provided for the sake of illustration. Therefore, the effects of this preferred embodiment are not limited to the numerical values herein presented.

First, a liquid crystal display device that was actually used includes an insulating film, which has been patterned with a film thickness of 740 nm, and a pixel electrode, which has been patterned with a film thickness of 140 nm.

Furthermore, an alignment film was manufactured by printing a polyimide film for parallel orientation on a TFT substrate and on an opposing substrate, baking in an oven for one hour at 200° C., and achieving a film thickness of approximately 100 nm after baking. Then the alignment films were rubbed in a single direction with a cotton cloth in such a way that the TFT substrate and the opposing substrate would have directions of orientation that are parallel to each other when the two substrates are coupled together.

Next, an appropriate amount of plastic spacers, which have a diameter of 5 μm, is dry sprayed on the TFT substrate, a sealant is printed at the display periphery on the opposing substrate, and the two substrates are aligned and coupled together. In an actual alignment process, a heat-cured resin was used as the sealant, and an hour and a half of baking was conducted in a pressurized oven at 170° C. Liquid crystal is injected using a vacuum injection method. A liquid crystal display device, created using the method thus described, was used for an experiment in this preferred embodiment.

Next, a verification process described below was conducted in order to evaluate the performance of the liquid crystal display device that was actually used. In order to transition the liquid crystal molecules from the spray orientation to the bend orientation, a +15 V voltage is applied on a gate bus line, and a 0 V voltage is applied on a source bus line. Furthermore, a +10 V voltage is applied on an accumulation capacitance bus line and a −10 V voltage is applied on an electrode on the opposing substrate. With the application of these voltages, an orientation transition from the spray orientation to the bend orientation spread across the entire display. All pixels have been verified to have transitioned into the bend orientation in approximately 5 seconds.

Next, the optical characteristics of the liquid crystal panel that has been created was evaluated. The signals normally used for a TFT drive were applied as input to the gate bus line, source bus line, accumulation capacitance bus line, and the opposing electrode. When the voltages were switched rapidly between ON and OFF, rapid responses of several millisecond or less was verified. Here, ON and OFF correspond to a relatively high voltage and a relatively low voltage applied on the liquid crystal layer, respectively, and also correspond to the displays of black and white colors, respectively. In this example, the ON voltage was 10 V and the OFF voltage was 2 V. Furthermore, because the entire display is in the bend orientation, a combination with a phase difference plate for view angle compensation resulted in wide view angles with the black colored state observable even at a wide view angle.

Furthermore, after the evaluation on the liquid crystal display device performance and the liquid crystal panel optical characteristics, experiments were conducted on a reverse transition. The power supply was turned off to stop the display in order to transition the liquid crystal molecules from the bend orientation to the twist orientation. Specifically, a 0 V voltage was applied to the gate bus line, source bus line, accumulation capacitance bus line, and to the opposing electrode. After the power supply was turned off, a voltage of +10 V was applied only to the accumulation capacitance bus line and was held for one second, and a voltage of 0 V was thereafter applied. Here, the voltage was applied on the accumulation capacitance bus line after the power supply was turned off. The longer the delay was for the voltage to be applied on the accumulation capacitance bus line, the longer the time required for the entire display to achieve a uniform spray orientation after the power supply was turned off. Therefore, it is desirable to apply the voltage on the accumulation capacitance bus line as quickly as possible after the power supply is turned off. It is most preferable that the voltage be applied on the accumulation capacitance bus line simultaneously as the power is turned off.

Here, the voltage on the accumulation capacitance bus line was applied for a time span of one second, but this time span may be shorter as long as the liquid crystal responds adequately. With the nematic liquid crystal operating at −30° C., for example, the liquid crystal response time is approximately 500 milliseconds, and the voltage only needs to be applied for a time span of 500 milliseconds. At room temperature (+25° C.), the response time is approximately 50 milliseconds, and the voltage needs to be applied for only 50 milliseconds.

The power supply was turned off, and the entire display went through a transition from the bend orientation to the twist orientation. Then, a voltage of +10 V, followed by a voltage of 0 V, was applied only on the accumulation capacitance bus line. As a result, the entire screen went through a color change and transitioned to a uniform display after 5 seconds. Because the screen no longer showed any additional changes in the display state, the entire screen was determined to have reverted back to the initial state of a uniform spray orientation.

These transitions were next observed under a microscope. A voltage of +10 V was applied only on the accumulation capacitance bus line, and then a voltage of 0 V was applied on the accumulation capacitance bus line, and the image in FIG. 7 was then immediately captured. FIG. 7 shows that the spray orientation originates from an opening of each pixel. All pixels were verified to have transitioned from the twist orientation to the spray orientation after 5 seconds.

For comparison, a voltage of 0 V was applied to the accumulation capacitance bus line, as in the case of other bus lines, after the power supply was turned off. In this case, it took a while for the entire screen to transition from the twist orientation to the spray orientation. The spray orientation originated from the outside portion of the screen that was not in the bend orientation, and spread toward the center of the screen. The entire screen was verified to have achieved a uniform spray orientation after approximately 10 minutes.

For another comparison, a voltage of +5 V was applied only on the accumulation capacitance bus line and was held for 1 second, and then a voltage of 0 V was applied after the power was turned off. The result of this experiment showed that the spray orientation was not generated in a portion of the screen, and the entire screen transitioned to the spray orientation as a result of the spray orientation originating at the periphery and then spreading. Although not shown in any figures, observation under a microscope revealed that at the moment when the voltage of 0 V was applied on the accumulation capacitance bus line after the application of +5 V, the spray orientation originated from approximately 80% of the pixels and the pixels in which the spray orientation did not originate transitioned into the spray orientation as a result of a spread of the spray orientation from the periphery. Thus, ultimately, the entire screen transitioned to the spray orientation.

When the voltage applied on the accumulation capacitance bus line was lowered to Vcr (the minimum voltage at which the bend orientation can be maintained) of +2 V, the spray orientation was not generated in almost any of the pixels. The spray orientation was generated only at a portion of the screen. Furthermore, the spray orientation was not generated at a voltage lower than Vcr. These results show that the orientation transition from the twist orientation to the spray orientation was significantly affected by the voltage applied on the accumulation capacitance bus line, similar to the orientation transition from the spray orientation to the bend orientation.

In other words, the higher the voltage applied on the accumulation capacitance bus line, the higher the probability for the spray orientation to occur. In order to ensure rapid and uniform generation of the spray orientation, the voltage applied on the accumulation capacitance bus line should be as high as possible. However, an expensive power supply circuit would be required for applying a high voltage on the accumulation capacitance bus line. Therefore, the voltage applied on the accumulation capacitance bus line should be made as low as possible while achieving close to a 100% probability in generating the spray orientation.

In the present experiment, all of the pixels were verified to transition from the twist orientation to the spray orientation when the voltage applied on the accumulation capacitance bus line was +10 V. Therefore, if the power supply voltage required for the transition from the spray orientation to the bend orientation is +10 V or above, the same power supply (or power supply circuit) also serves as the power supply required for the transition from the twist orientation to the spray orientation and eliminates the additional cost for adding a multitude of power supplies for different purposes.

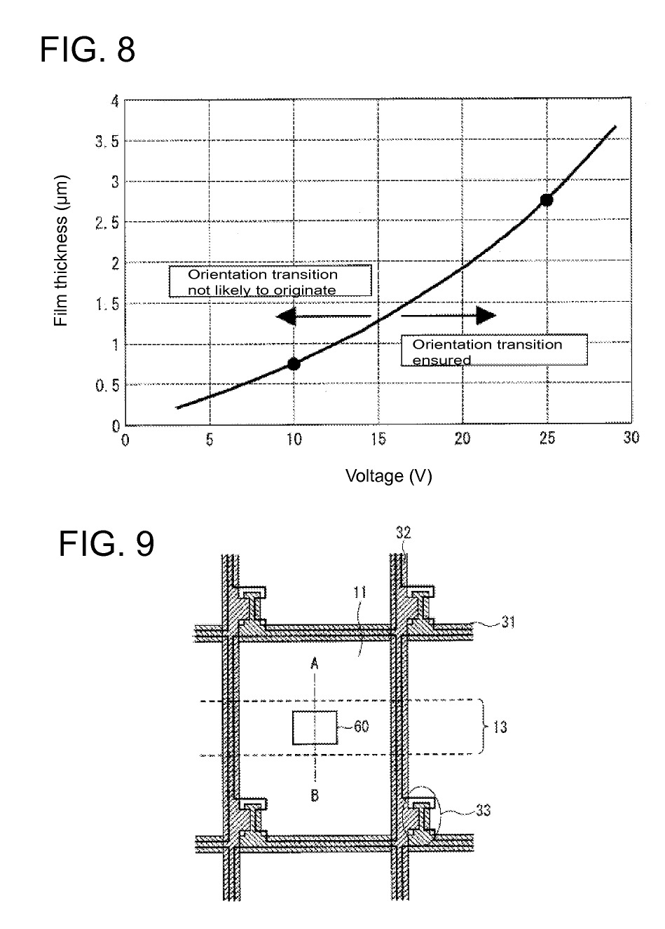

FIG. 8 shows a relationship between the voltages applied on the accumulation capacitance bus line and the thickness of the insulating film formed between the accumulation capacitance bus line and the pixel electrode according to preferred embodiments.

In FIG. 8, an area to the right side of the curve represents conditions under which the transition from the twist orientation to the spray orientation is ensured, while an area to the left side of the curve represents conditions under which the transition to the spray orientation does not occur in some regions. In a liquid crystal panel, the highest voltage is applied on the gate bus line. The voltage typically used is approximately 10 V to 15 V. Therefore, if it is possible to use the same power supply used for the voltage applied on the gate bus line for the transition to the spray orientation, there will be no need to use an additional power supply. This will result in a smaller liquid crystal display device, a simplified device, and a reduction in cost. According to the curve in FIG. 8, the orientation transition will be ensured with a voltage of 13 V or less, if it is possible to have an insulating film thickness of 1 μm or less; and the same power supply can be used for applying voltage on the gate bus line and for the orientation transition to the spray orientation. As a result, the liquid crystal display device will be made smaller, the device will be simplified, and the cost will be reduced, as described above. On the other hand, a thickness of around 500 nm is required for the insulating film for protecting the gate bus line in order to ensure insulation. Therefore, a voltage of approximately 7 V would be required in order to ensure the transition, according to FIG. 8.

The twist orientation can be verified by the following means. The polarization plates are placed in such a way as to achieve a crossed Nicols state, and the panel is placed between the two polarization plates in such a way that the direction of rubbing would be parallel to the absorption axis of one of the polarization plates. While the liquid crystal molecules that are in the spray orientation or the bend orientation are positioned within planes that are parallel to the direction of rubbing and produce dark display, the liquid crystal molecules in the twist orientation are not subject to optical phase cancellations and produce colored display. This method makes it possible to verify whether the liquid crystal layer is in the twist orientation or not.

### Preferred Embodiment 2

A preferred embodiment that will be described next relates to a liquid crystal display device 75 that has a pixel aperture ratio larger than in the preferred embodiment 1 and that realizes a rapid reverse transition.

A larger aperture ratio is achieved by creating an interlayer insulating film between a pixel electrode and a second glass substrate in order to prevent a conduction between the pixel electrode and a gate bus line or source bus line, so that the pixel electrode may be overlaid in parallel with the gate bus line and the source bus line, as shown in FIG. 9.

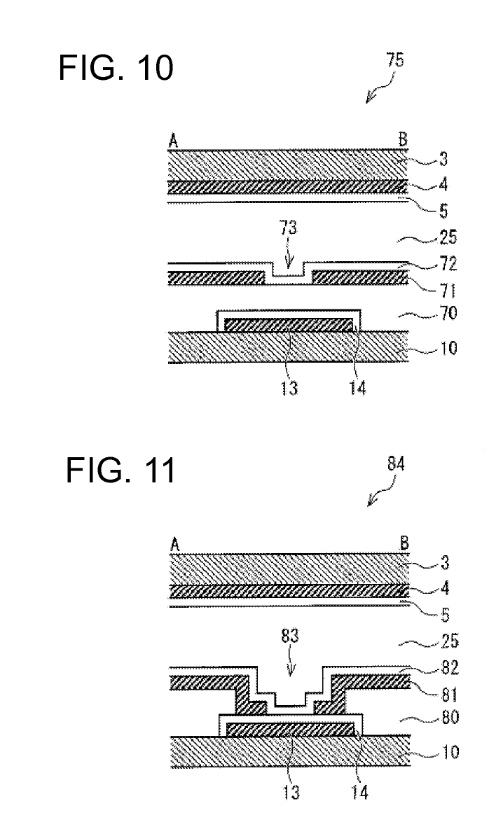

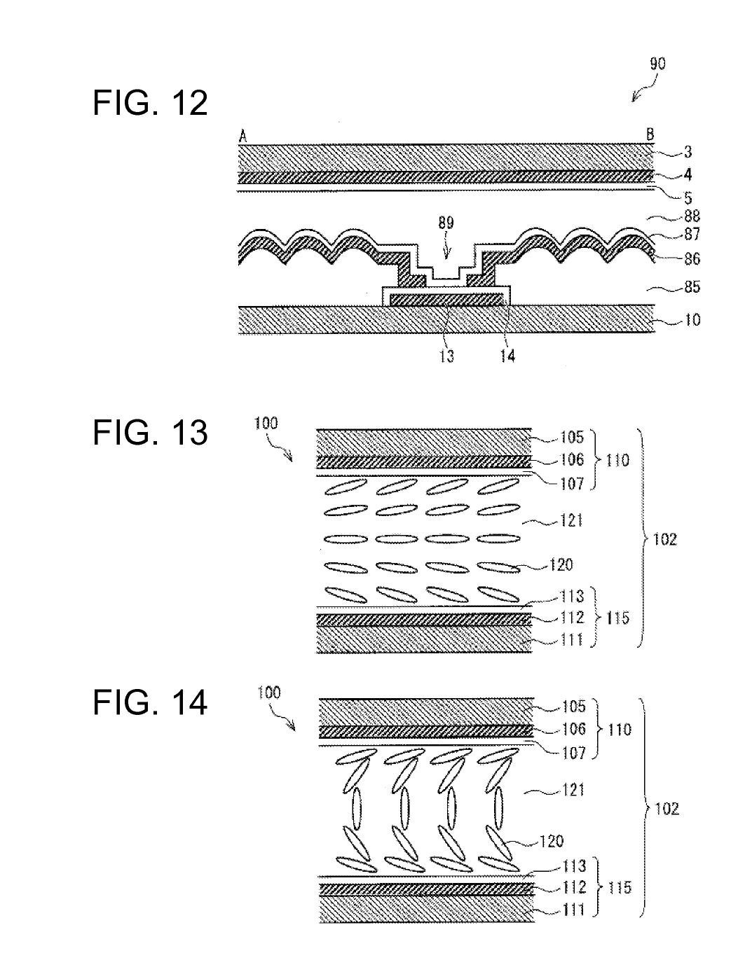

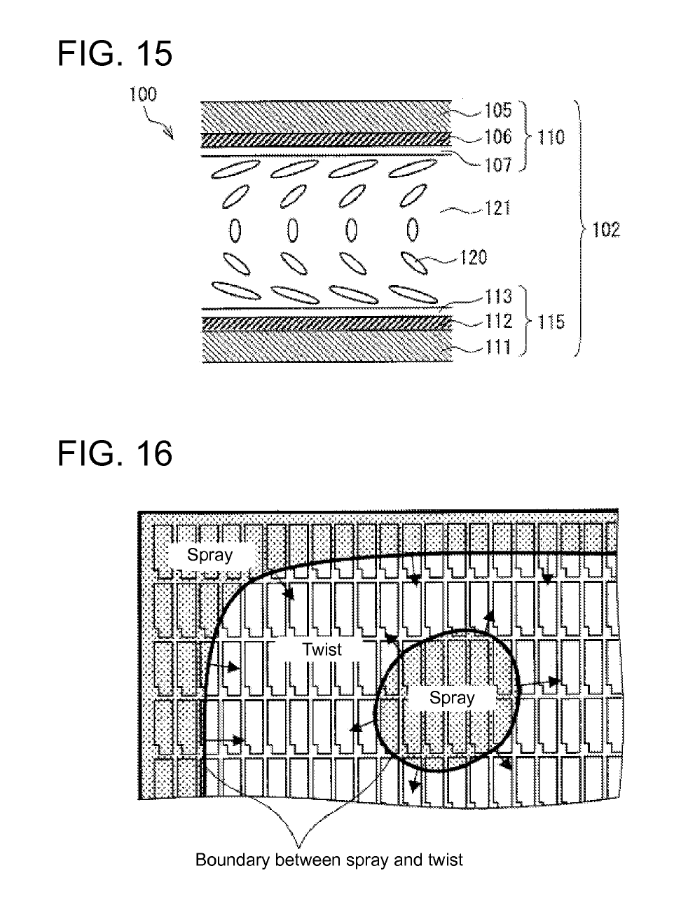

As shown in FIG. 10, an insulating film 70, which is an interlayer insulating film, has been created. Here, the same reference numerals have been assigned to the various elements that are identical to the elements described with reference to FIG. 1. Therefore, detailed descriptions on these elements are omitted.

A method of manufacturing the insulating film 70 will be described next. Here, it is assumed that the accumulation capacitance bus line 13 and the insulating film 14 have already been formed on the second glass substrate 10 using a method similar to those described above.

First, a photoresist, made of a polymer material, was coated by spin coating, and then a contact hole was created atop the drain electrode by lithography and development in order to establish a conduction to the drain electrode. Then, baking in an oven at around 180° C. was performed for curing. The thickness of the insulating film 70 averaged at 2 μm after curing. While the polymer material used was a positive resist, a negative resist may also be used.

Then, a pixel electrode 71 was deposited by sputtering and was patterned by a photolithography process. The thickness of the pixel electrode was 140 nm. While a transparent electrode material of ITO was used for the pixel electrode 71, any other transparent thin film conductive material, including IZO, may also be used. Then, the same method of manufacturing the liquid crystal display device as described above was subsequently used. The thickness of an alignment film 72 formed atop the insulating film 70 and the pixel electrode 71 was 100 nm. As shown in FIG. 10, the accumulation capacitance bus line 13 was formed on the second glass substrate 10 in such a way as to overlap the pixel electrode 71 through the insulating films 14 and 70 interposed therebetween. And an opening 73 was created in the pixel electrode 71 in a portion of the region in which the pixel electrode 71 overlaps the accumulation capacitance bus line 13 through the insulating films 14 and 70 interposed therebetween.

The liquid crystal display device 75 thus created was evaluated. The manufacturing of the insulating film 70 results in a 20% improvement in the aperture ratio from 50% to 60% and a brighter display. Next, the power supply was turned off to stop the screen display in order to transition the liquid crystal molecules from the bend orientation to the twist orientation. Specifically, a voltage of 0 V was applied to the gate bus line, source bus line, accumulation capacitance bus line 13, and to the opposing electrode 4. After the power supply was turned off, a voltage of +10 V was applied only on the accumulation capacitance bus line 13 and was held for one second, and then a voltage of 0 V was applied. Then the subsequent state was observed.

The result showed that the spray orientation was generated from the openings 73 in a portion of the display. However, the generation of the spray orientation was not observed in the majority of the openings 73. It is believed that the voltage applied between the accumulation capacitance bus line 13 and the pixel electrode 71 was diminished due to the existence of the insulating film 70 between the accumulation capacitance bus line 13 and the pixel electrode 71. When the voltage applied on the accumulation capacitance bus line 13 was raised to +25 V in the next experiment, the spray orientation was generated in all of the pixels under observation, and the entire screen showed a uniform spray orientation after 5 seconds.

The above results lead to the following conclusions on the effects of the present preferred embodiment. The insulating film 70, which is formed between the pixel electrode 71 and the second glass substrate 10, prevents conduction between the pixel electrode 71 and the gate and source bus lines and, as a result, the pixel electrode 71 can be overlaid in parallel which the gate bus line and the source bus line in order to increase the aperture ratio. Although the voltage applied between the accumulation capacitance bus line 13 and the pixel electrode 71 is diminished due to the existence of the insulating film 70 between the accumulation capacitance bus line 13 and the pixel electrode 71, a rapid transition from the twist orientation to the spray orientation across the entire screen is possible when a higher voltage is applied between the accumulation capacitance bus line 13 and the pixel electrode 71.

For the sake of comparison, the accumulation capacitance bus line 13 was set at 0 V, like the other bus lines, with no voltage being applied after the power was turned off. Then, it took some time for the entire screen to transition into the spray orientation. A uniform spray orientation was verified only after approximately 10 minutes.

### Preferred Embodiment 3

This preferred embodiment relates to a liquid crystal display device 84 that has the insulating film 70 as described in the preferred embodiment 2 in which the insulating film 70 is removed by patterning only in the vicinity of the opening 73. FIG. 11 is a cross-sectional diagram of the liquid crystal display device 84. Elements that are identical to those described with reference to FIG. 1 are assigned the same reference numerals as FIG. 1. Therefore, detailed descriptions of these elements are omitted.

As shown in FIG. 11, the accumulation capacitance bus line 13 is formed on the second glass substrate 10 in such a way as to overlay a pixel electrode 81 through the insulating films 14 and 80 interposed therebetween. Furthermore, an opening 83 is created in the pixel electrode 81 in a portion of the area where the pixel electrode 81 overlaps the accumulation capacitance bus line 13 through the insulating film 14 interposed therebetween.

As a comparison between FIG. 10 and FIG. 11 shows, the insulating film 70 always exists between the accumulation capacitance bus line 13 and the pixel electrode 71 in the liquid crystal display device 75 in FIG. 10. However, an insulating layer that corresponds to the insulating film 70 is removed atop the accumulation capacitance bus line 13 (upper side in FIG. 11) in the liquid crystal display device 84 of FIG. 11, and the pixel electrode 81 is formed in its place. Therefore, the opening 83 is formed in such a way that an alignment film 82 formed at the bottom of the opening 83 is in contact with the insulating film 14. In other words, the opening 83 has a structure similar to the opening 15 of the liquid crystal display device 1.

Other conditions, such as the respective film thicknesses of the pixel electrode 81, alignment film 82, and insulating film 80, are similar to those in the preferred embodiment 2, and their descriptions are omitted here.

The liquid crystal display device 84 that has been thus manufactured was evaluated. The aperture ratio improved by 20% over the aperture ratio of the preferred embodiment 1, and a brighter display was realized. Next, the power supply was turned off to stop the screen display in order to transition the liquid crystal molecules from the bend orientation to the twist orientation as in the preferred embodiment 1. Specifically, a voltage of 0 V was applied to the gate bus line, source bus line, accumulation capacitance bus line 13, and to the opposing electrode 4. After the power supply was turned off, a voltage of +10 V was applied only on the accumulation capacitance bus line 13 and was held for 1 second, and then a voltage of 0 V was applied. Then the state thereafter was observed.

As a result, the spray orientation was observed to have been generated in all of the openings 83. Because an insulating film comparable to the insulating film 70 in the liquid crystal display device 75 does not exist near the opening 83, when the same voltage as in the preferred embodiment 1 was applied between the accumulation capacitance bus line 13 and the pixel electrode 71, results similar to the preferred embodiment 1 were realized. These results show that the voltage applied between the accumulation capacitance bus line 13 and the pixel electrode 71 can be reduced while the aperture ratio is increased in this preferred embodiment. In other words, this preferred embodiment achieves the results similar to the preferred embodiment 1 while also achieving a higher aperture ratio.

### Preferred Embodiment 4

The preferred embodiment described next relates to a liquid crystal display device 90 in which the insulating film 80 of the preferred embodiment 3 is equipped with a rough surface on the side of the liquid crystal layer, and in which a reflective thin film conductive material, such as an alloy, a main component of which is Al, Ag, Al or Ag, is used as the pixel electrode instead of ITO. In other words, this preferred embodiment relates to a reflection type liquid crystal display. Here, the surface roughness can be created simultaneously when the insulating film in the vicinity of the opening is patterned.

Here, the same reference numerals are assigned to the elements that are identical to those described with reference to FIG. 1. Therefore, detailed descriptions of these elements are omitted here. Furthermore, other conditions, including the respective film thicknesses of the pixel electrode 86, alignment film 87, and insulating layer 85, are the same as those in the preferred embodiment 3, and their descriptions are omitted here. The liquid crystal display device 84, which has been thus manufactured, was evaluated. The aperture ratio was improved by 20% over the aperture ratio in the preferred embodiment 1, and a brighter display was realized. Next, the power supply was turned off to stop the screen display in order to transition the liquid crystal molecules from the bend orientation to the twist orientation as in the preferred embodiment 1. Specifically, a voltage of 0 V was applied to the gate bus line, source bus line, accumulation capacitance bus line 13, and to the opposing electrode 4. After the power was turned off, a voltage of +10 V was applied only on the accumulation capacitance bus line 13 and was held for 1 second, and then a voltage of 0 V was applied. Then the subsequent state was observed.

As a result, the entire screen changed in color and switched to a uniform display after 5 seconds. Because there was no change in the display state thereafter, it was determined that the entire screen had reverted to a uniform spray orientation, which is the initial state.

For the sake of comparison, a voltage of 0 V was applied on the accumulation capacitance bus line, like the other bus lines, after the power was turned off. Then, it took some time for the entire screen to transition from the twist orientation to the spray orientation. The spray orientation was generated from the periphery of the screen that was not in the bend orientation, and spread into the screen. The entire screen was verified to have transitioned into a uniform spray orientation only after approximately 10 minutes.

A transmission-type liquid crystal display device would have no significant problem, as long as the backlight is turned off at the same time as the power is turned off. However, spotted patterns would always be observed on the screen of a reflection type liquid crystal display device or the reflection-transmission type liquid crystal display device, which relies on the ambient light as a light source, as long as a mixture of the twist orientation and the spray orientation remains. Therefore, the preferred embodiments of the present invention, which enable the screen to revert back into a uniform state in several seconds, are considered very useful for the reflection liquid crystal display devices and the reflection-transmission type liquid crystal display devices.

The experiment related to the reflection type liquid crystal display device has been described only for the preferred embodiment 4, but it has also been verified that the same effects, which are realized in the preferred embodiments 1 through 3, are realized in the preferred embodiment 4, in which a reflective thin film conductive material made of, for example, Al or Ag instead of ITO is used for the pixel electrode. Therefore, similar results should be achieved in the preferred embodiments 1 through 3, when a reflective thin film conductive material is used for the pixel electrode.

The structures, operations, and effects of the present invention have been described above by describing the various preferred embodiments and examples. However, the present invention is not limited to the various forms of preferred embodiments described above, and various modifications are possible within the scope set forth in the claims. Embodiments obtained by appropriate combinations of the technological means disclosed in each of the various embodiments also fall within the scope of technologies of the present invention.

The aforementioned opening is preferably created in each of the aforementioned pixels in the liquid crystal display device of the present invention.

With the structures described above, it becomes possible to transition the entire screen from the twist orientation to the spray orientation in a time span for transitioning one pixel from the twist orientation to the spray orientation. As a result, a rapid and uniform transition to the spray orientation across the entire screen can be realized when the image display is stopped.

In the liquid crystal display device of the present invention, it is preferable that the aforementioned first substrate and the aforementioned second substrate have respective alignment films that are rubbing treated in an identical rubbing direction on the side of the aforementioned liquid crystal layer, respectively, and it is also preferable that electric fields generated in the aforementioned opening under the aforementioned voltage are applied in a direction parallel to the aforementioned direction of rubbing.

The liquid crystal molecules in the twist orientation twist by 180° between the first substrate and the second substrate and are orthogonal to the direction of rubbing at the center of the liquid crystal layer. Therefore, when an electric field is applied on the liquid crystal molecules at the center of the liquid crystal layer in a direction parallel to rubbing, the liquid crystal molecules are unable to maintain the twist orientation and, as a result, transition into the spray orientation. In other words, application of the electric field in a direction parallel (or anti-parallel) to rubbing can more effectively realize an orientation transition from the twist orientation to the spray orientation.

In the liquid crystal display device of the present invention, the thickness of the aforementioned insulating layer is preferably thinner in the vicinity of the aforementioned opening compared with regions outside of the vicinity of the aforementioned opening.

Furthermore, in the liquid crystal display device of the present invention, the thickness of the aforementioned insulating layer is preferably 1 μm or less in the vicinity of the aforementioned opening.

A potential difference must be created between the pixel electrode and bus line in order to transition the liquid crystal molecules from the twist orientation to the spray orientation. The magnitude of this electric field is larger when the potential difference between the pixel electrode and bus line is larger and when the thickness of the insulating layer formed between the pixel electrode and the bus line is smaller. Therefore, even when the thickness of the insulating layer is large in the region outside of the vicinity of the opening, a stronger electric field can be generated from the opening, as long as the insulating layer is thinner in the vicinity of the opening. As a result, an orientation transition from the twist orientation to the spray orientation can be realized more effectively.

When the insulating layer film thickness can be made 1 μm or less, the bias voltage required for a reverse transition from the twist orientation to the spray orientation can be made smaller than the bias voltage on the gate bus line, which is the largest in the liquid crystal panel, and a common power supply can be used for applying the voltages for the reverse transition and for applying voltage on the gate bus line. As a result, a smaller liquid crystal display device, simplified device, and cost reduction can be achieved while a rapid transition from the twist orientation to the spray orientation is also realized.

In the liquid crystal display device of the present invention, the aforementioned bus line is preferably the gate bus line or source bus line formed on the aforementioned first substrate.

When the gate bus line or the source bus line formed on the first substrate is the aforementioned bus line, the need for forming a new bus line is eliminated. As a result, a smaller liquid crystal display device, simplified device, and reduction in cost are realized while a rapid transition from the twist orientation to the spray orientation is also realized.

In the liquid crystal display device of the present invention, the aforementioned pixel electrode is preferably be a transparent electrode.

When the liquid crystal display device is a transmission type having a transparent electrode as the pixel electrode, spot patterns across the screen, caused by the existence of a mixture of the spray orientation and the twist orientation, can be avoided as long as the backlight is turned off at the same time as the power supply is turned off. However, slight spot patterns are sometimes visible even when the backlight is turned off. In such an instance, a rapid orientation transition from the twist orientation to the spray orientation can be realized with the electric field originating from the aforementioned opening, even for the transmission type having transparent electrodes.

The liquid crystal display device of the present invention is preferably a reflection type having a reflective plate that reflects the ambient light.

The liquid crystal display device of the present invention is preferably a reflective-transmission type having a reflective plate for reflecting the ambient light and a backlight placed on the back side of the aforementioned first substrate.

When the spray orientation and the twist orientation coexist across the screen, spot patterns appear on the screen. This problem would not be significant in a transmission type liquid crystal display device, if the backlight is turned off at the same time as the power is turned off. However, the problem would be significant in a reflection type liquid crystal display device and a reflection-transmission-type liquid crystal display device, which rely on the ambient light as the source of light. Therefore, application of the present invention on the reflection type or the reflection-transmission type can better ensure an orientation transition from the twist orientation to the spray orientation and offer a better solution for the aforementioned spotting problem.

As described above, a structure of the liquid crystal display device of the present invention includes a bus line for applying a voltage with respect to a pixel electrode, which is formed on a first substrate in such a way as to overlap the pixel electrode through an insulating layer interposed therebetween, and an opening created in the pixel electrode in a portion of the region where the pixel electrode and bus line overlap through the insulating layer interposed therebetween.

Therefore, the liquid crystal display device of the present invention achieves an effect of a rapid orientation transition from the twist orientation to the spray orientation.

### POTENTIAL INDUSTRIAL APPLICATIONS

The liquid crystal display device of the present invention can be applied to a liquid crystal display device, and specifically to a liquid crystal display device of the OCB mode, which is a liquid crystal display device that achieves a rapid orientation transition from the twist orientation to the spray orientation.

### DESCRIPTION OF REFERENCE NUMERALS

1, 75, 84, 90 liquid crystal display device

2 liquid crystal panel

3 first glass substrate

4 opposing electrode

5, 12, 82, 87 alignment film

7 opposing substrate (second substrate)

10 second glass substrate

11, 71, 81, 86 pixel electrode

13 accumulation capacitance bus line (bus line)

14, 70, 80, 85 insulating film

15, 73, 83 opening

20 TFT substrate (first substrate)

25 liquid crystal layer

30 pixel

31 gate bus line

32 source bus line

33 TFT

40 liquid crystal control circuit

41 signal source

42 liquid crystal panel

43 clock signal

44 gradation signal

45 accumulation capacitance bus line signal

46 opposing electrode signal

47 power supply circuit

48 orientation transition control signal for opposing electrode

49 orientation transition control signal for accumulation capacitance bus line

50 relay circuit

51 power supply signal

1. A liquid display device comprising:
a first substrate;
a second substrate;
a liquid crystal layer sealed between said first substrate and said second substrate; and
a plurality of pixels disposed in a matrix,
wherein a pixel electrode is provided on the first substrate corresponding to each pixel of said plurality of pixels,
wherein said liquid display device is an OCB-mode liquid crystal display device in which liquid crystal molecules included in said liquid crystal layer are in a spray orientation when no voltage is applied to said liquid crystal layer, transition from the spray orientation to a bend orientation when a voltage is applied to said liquid crystal layer, and transition from the bend orientation to a twist orientation when the voltage applied drops to or below a specific level while in a state of the bend orientation,
wherein said liquid crystal display device further comprises a bus line formed on said first substrate to overlap said pixel electrode through an insulating layer interposed therebetween to apply a voltage relative to said pixel electrode, and
wherein said pixel electrode has an opening in a portion of a region over which said pixel electrode overlaps said bus line through said insulating layer interposed therebetween.

2. The liquid crystal display device according to claim 1, wherein said opening is formed on each of said pixels;

3. The liquid crystal display device according to claim 1, wherein said first substrate and said second substrate include, respectively, an alignment film, which has been rubbing treated in a single rubbing direction, on a side of said liquid crystal layer; and
wherein an electric field generated in said opening due to said voltage is applied in a direction parallel to said rubbing direction.

4. The liquid crystal display device according to claim 1, wherein said insulating layer is formed in such a way that the thickness of said insulating layer is smaller in a vicinity of said opening than in regions not in the vicinity of said opening.

5. The liquid crystal display device according to claim 1, wherein said insulating layer has a film thickness of 1 μm or less in a vicinity of said opening.

6. The liquid crystal display device according to claim 1, wherein said bus line is a gate bus line or a source bus line formed on said first substrate.

7. The liquid crystal display device according to claim 1, wherein said pixel electrode is a transparent electrode.

8. The liquid crystal display device according to claim 1, wherein said liquid crystal display device is a reflection type and includes a reflective plate for reflecting ambient light.

9. The liquid crystal display device according to claim 1, wherein said liquid crystal display device is a reflection-transmission type and includes a reflective plate for reflecting the ambient light and a backlight placed behind said first substrate.
